(19) United States
(12) Patent Application Publication
(10) Pub. No.: US 2013/0030851 A1
(43) Pub. Date: Jan. 31, 2013

(54) PROJECT CLUSTERING AND RELATIONSHIP VISUALIZATION

(71) Applicants: Maher Rahmouni, Bristol (GB); Marianne Hickey, Bristol (GB); Claudio Bartolini, Menlo Park, CA (US)

(72) Inventors: Maher Rahmouni, Bristol (GB); Marianne Hickey, Bristol (GB); Claudio Bartolini, Menlo Park, CA (US)

(21) Appl. No.: 13/637,814

(22) PCT Filed: Apr. 9, 2010
(86) PCT No.: PCT/US10/30530

§ 371 Date: Sep. 27, 2012

(51) Int. Cl. G06Q 10/06

(52) U.S. Cl. 705/7.11

(57) ABSTRACT

Methods, computer-readable media, and systems are provided for displaying project relationships. One method for displaying project relationships includes providing a plurality of nodes (104A-F, 204, 204W-Z, 304W) on an electronic display, each node (104A-F, 204, 204W-Z, 304W) representing a project. The plurality of nodes (104A-F, 204, 204W-Z, 304W) are arranged about the electronic display according to a number of forces acting on each node (104A-F, 204, 204W-Z, 304W). The number of forces includes a constant attractive force (212) between each of the plurality of nodes (104A-F, 204, 204W-Z, 304W) and an origin position (201, 301) of the electronic display, a repulsive force (110, 210) between each pair of nodes (104A-F, 204, 204W-Z, 304W) proportional to the distance therebetween, and an attractive force between connected nodes (104A-F, 204, 204W-Z, 304W) proportional to the measure of similarity. A connection (106-1, 106-2, 106-3, 206-1, . . . , 206-7, 206-10, 306-5, . . . , 306-10) is shown between certain pairs of nodes (104A-F, 204, 204W-Z, 304W) to indicate existence of at least a threshold measure of similarity between projects represented by the connected nodes (104A-F, 204, 204W-Z, 304W). At least one characteristic of the connection (106-1, 106-2, 106-3, 206-1, . . . 206-7, 206-10, 306-5, . . . 306-10) visually indicates a measure of the similarity.

### BACKGROUND

Project managers can have responsibility for thousands of active projects and proposals for projects, which must be planned, organized, prioritized, selected for implementation, implemented, and managed (e.g., transition to an operational enterprise or asset). Information technology (IT) is one area typically involving many active projects and proposals for projects, such as the installation and/or configuration of computing devices.

An enterprise, such as a business entity, may have a portfolio of past, present, and future IT projects. The efficiency of more recent projects can be improved by learning from past experiences from other projects, such as those that have already been planned, implemented, operational, failed, terminated, and/or rejected. The difficulty is in determining which past projects can provide desired insight applicable to a more recent project.

In the course of a portfolio management process, it may be difficult to efficiently navigate a given set of projects. For example, finding projects of particular interest and/or understanding relationship(s) between projects can be challenging where the set of projects includes a large quantity of diverse projects, or projects separated by time, geography, technology, and/or organizational boundaries. Databases have been used to store and provide a wealth of information associated with one or more projects. Keyword searches, and other types of data mining reporting, can indicate commonalities and/or dissimilarities, between project data. However, due to the quantity and diversity of projects, the number and variety of variables that may be applicable to individual projects, and the complicated nature of project relationships, it can be difficult for a human to efficiently ascertain how particular projects may, or may not, be related to one another.

### BRIEF DESCRIPTION OF THE DRAWINGS

FIG. 1 is a project relationship diagram illustrating various strength of similarity relationships, according to one or more embodiments of the present disclosure.

FIG. 2 is a project relationship diagram having a similarity threshold of 0.35, according to one or more embodiments of the present disclosure.

FIG. 3 is a project relationship diagram having a similarity threshold of 0.5, according to one or more embodiments of the present disclosure.

### DETAILED DESCRIPTION

Methods, computer-readable media, and systems are provided for displaying project relationships. One method for displaying project relationships includes providing a plurality of nodes on an electronic display, each node representing a project. The plurality of nodes are arranged about the electronic display according to a number of forces acting on each node. The number of forces includes a constant attractive force between each of the plurality of nodes and an origin position of the electronic display, a repulsive force between each pair of nodes proportional to the distance therebetween, and an attractive force between connected nodes proportional to the measure of similarity. A connection (e.g., edge) is shown between certain pairs of nodes to indicate existence of at least a threshold measure of similarity between projects represented by the connected nodes. At least one characteristic of the connection visually indicates a measure of the similarity.

Projects, such as information technology (IT) projects to install. program, modify, etc. computing devices and systems, can be implemented across large geographic, organizational, and/or time expanses. However, certain of these projects may be related in a number of ways to certain other projects. The existence of a particular project, or the relationship among a number of projects, may not be readily appreciated. Project data may be stored, and used manually or by automated analysis, to evaluate the existence and/or strength of inter-project relationships according to one or more measures of project relatedness (e.g., variables), and the strength (e.g., degree) of similarity by which the projects are related. One example of evaluating project relationships, establishing connectedness according to selected criteria, and measuring the relative strength of inter-project relationships (e.g., similarity) is described in the PCT Patent Application entitled “Method and System For Comparing And Locating Projects,” filed on the same date as the present application, and corresponding to HP Invention Disclosure 200903690-1, which is herein incorporated by reference into the present application.

The analysis to determine and/or quantify the relationship between projects (e.g., similarity of the projects) can be based on user-selected project attributes, such as cost, technology, duration, type of data, etc. Each project attribute can also be weighted, for example, to reflect the importance to a quantitative similarity determination desired by an analyst (e.g., user) for a particular purpose of the study. The reader will appreciate that the relationship being quantified by the analysis can therefore be requested by the analyst by selecting certain project attributes and/or weight certain attributes differently. Thus the type of relationship being evaluated can be requested (e.g., selected, defined) by the analyst, as well as the threshold of similarity corresponding to the requested relationship type.

Once a plurality of projects are evaluated for the existence and strength of relationships therebetween (e.g., project relationship analysis), the results of the project relationship analysis can be presented according to one or more embodiments of the present disclosure, so as to illustrate the presence and quality, or lack thereof, of inter-project relationships. Illustrating relationships visually enables the assimilation of larger amounts of information and/or more complex information, more rapidly by a human analyst. Visually illustrating project relationships according to one or more of the embodiments of the present disclosure can enable a human analyst (e.g., user) to quickly ascertain quantitative and qualitative similarities, and dissimilarities, between various projects.

According to one or more embodiments of the present disclosure, the results of automated project relationship analysis are illustrated to produce a big picture view of the landscape among a group of projects (e.g., all projects, a subset of projects), so as to identify clusters of related projects, identify themes among the clusters and/or individual projects, indicate similarity between projects, and/or to identify one or more projects of interest (e.g., that are relevant to another project or projects-related decision process).

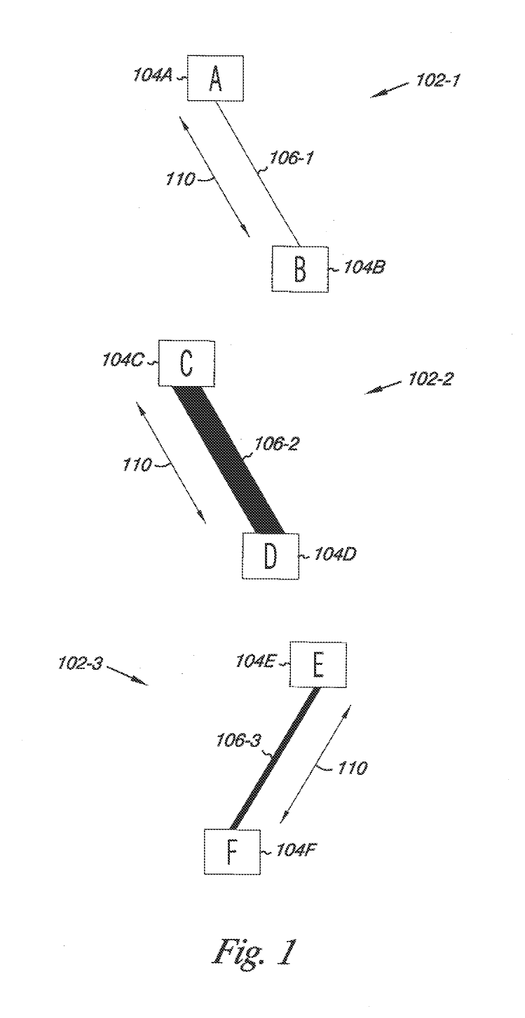

FIG. 1 is a project relationship diagram illustrating various strengths of similarity relationships, according to one or more embodiments of the present disclosure. According to one or more embodiments of the present disclosure, a number of projects can be visually displayed as nodes. For example, Project A can be illustrated on a display as node “A” 104A. Additional projects B-F can likewise be illustrated as corresponding nodes “B”-“F” respectively (e.g., 104B-104F).

As further shown in FIG. 1, the existence of a relationship between pairs of projects can be illustrated as a connection (e.g., edge) between pairs of nodes that correspond to the projects represented by the respective nodes. For example, a relationship between Projects A and B can be indicated by a connection 106-1 between node A 104A and node B 104B, a relationship between Projects C and C can be indicated by a connection 106-2 between node C 104C and node D 1040, and a relationship between Projects E and F can be indicated by a connection 106-3 between node E 104E and node F 104F.

Conversely, the absence of a relationship between particular pairs of projects can be indicated by the absence of a connection between pairs of nodes that correspond to the projects represented by the respective nodes. For example, the lack of a relationship between Projects B and C can be indicated by the absence of a connection between node 13 104B and node C 104C, as depicted in FIG. 1.

According to one or more embodiments of the present disclosure, the nodes representing particular projects can be activated (e.g., selected such as by clicking on, scrolled-over by a cursor, etc.) to provide additional information concerning the project that they represent. For example, when an analyst moves a cursor over a particular node (e.g., node A 104A), additional information for the project represented by node A (e.g., Project A) can be displayed. For example, data upon the existence and/or degree of similarity of projects relationships can be displayed, in total or in part. Alternatively, the node can include a link, such that an analyst selecting a particular node can be linked into a destination containing additional information concerning the project represented by the selected node. According to other embodiments, selecting a particular node can open a window of various options related to the associated project represented by the node that may be selected by the user.

According to one or more embodiments of the present disclosure, selecting a particular node can result in the relevant detailed information of the project represented by the node being displayed. Optionally, detailed information of nodes connected to the selected node (e.g., similar projects, related projects) also can be displayed, as can details relating to the importance and/or strength of the relationships between the selected node and connected nodes. Selecting a particular connection can result in the display of relevant detailed information regarding the relationship selected, and/or the projects to which the connection is made.

Clusters of inter-connected nodes indicate a group of projects related by at least the threshold measure of similarity. FIG. 1 shows three clusters of projects. Cluster 102-1 includes projects A and B, cluster 102-2 includes projects C and D, and cluster 102-3 includes projects E and F. While the clusters shown in FIG. 1 include only 2 nodes (e.g., projects represented by the nodes), embodiments of the present invention are not so limited, and clusters may include two or more nodes having at least one connection therebetween. That is, a cluster of N nodes can have at least N-1 connections between the N nodes, with each of the N nodes having at least one connection to at least one other of the N nodes.

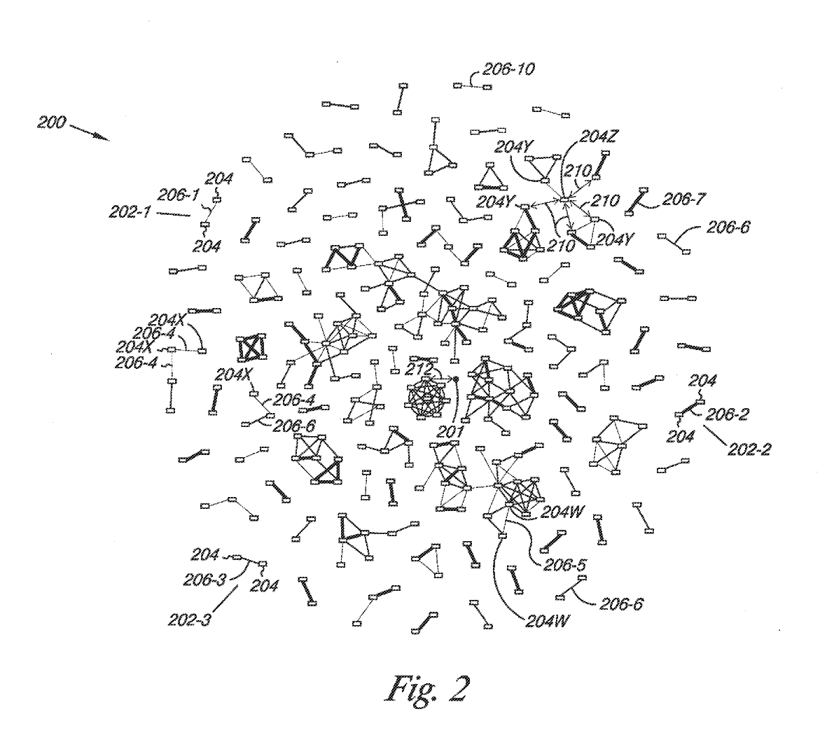

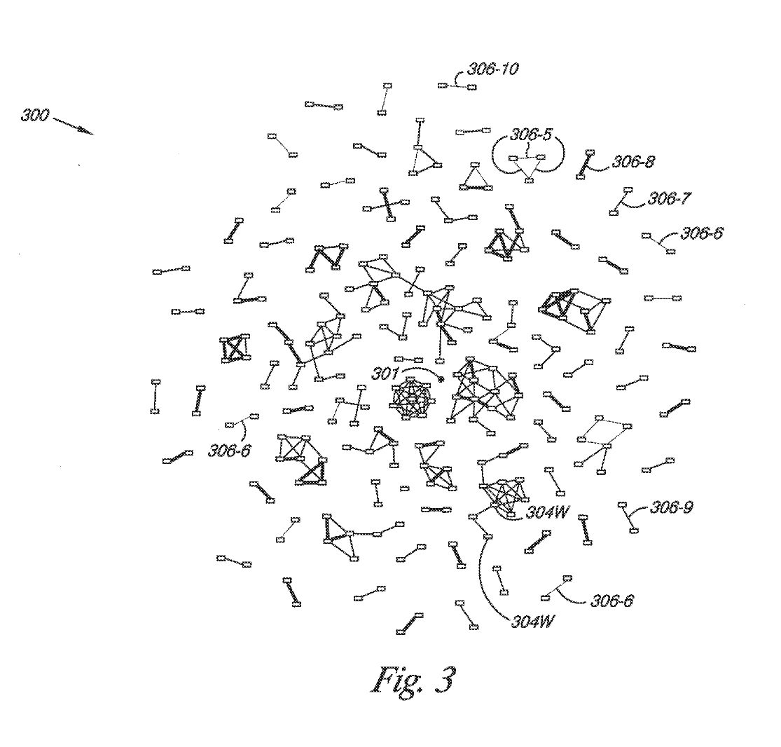

Clusters 102-1, 102-2, and 102-3 are comprised of two nodes representing projects, and one connection therebetween which indicates the existence of a relationship between the two projects of some threshold similarity. However, embodiments of the present invention are not limited to clusters of two projects. That is, clusters can be formed including more than two projects. Each project (e.g., represented by a node) can have an interconnection (e.g., edge) to more than one other project. Some examples of clusters having more than two nodes represent projects are illustrated in FIGS. 2 and 3.

A cluster does not necessarily (but can) indicate that each project is similarly related to all other projects. That is, some projects can be related to one portion of the projects of the cluster, but not sufficiently related to another portion of the projects of the cluster. However, each project of a cluster is related by at least the threshold similarity to at least one other project of the cluster.

The strength of relationships between pairs of projects of a cluster can vary as well. That is, a cluster does not necessarily indicate that all project relationships are the same, or of the same classification of similarity. Some projects may be related by weak similarity, others may have strong similarities to one another. Some pairs of projects may not be sufficiently related (e.g., have a relationship of at least the threshold similarity) for a connection to exist (e.g., be visible).

According to one or more embodiments of the present disclosure, the relationship between projects represented by a particular pair of nodes can be indicated by a characteristic of the connection between the particular pair of nodes. For example, the thickness of the connection between nodes can reflect the degree of similarity between the projects represented by the nodes. For example, connection 106-1 is shown being a thin connection, connection 106-2 is shown being a thick connection, and connection 106-3 is shown being an intermediate (e.g., medium) connection. The thin connection 106-1 between nodes A (e.g., 104A) and B (e.g., 104B) can represent a relatively weak relationship (e.g., similarity) between projects A and B. The thick connection 106-2 between nodes C (e.g., 104C) and D (e.g., 104D) can represent a relatively strong relationship (e.g., similarity) between projects C and D. The medium connection 106-3 between nodes E (e.g., 104E) and F (e.g., 104F) can represent a relationship (e.g., similarity) somewhere between weak and strong with respect to projects E and F.

According to one or more embodiments of the present disclosure, the characteristic (e.g., thickness, color shading, dashes) of a connection (e.g., edge) between two nodes can be proportional (e.g., linearly proportional) to the similarity between the projects represented by the two nodes. According to one or more embodiments, the characteristic (e.g., line thickness, line weight “w”) of a connection (e.g., edge) between two nodes can be proportional to the similarity (e.g., “s”) between the projects represented by the two nodes minus the threshold (e.g., “t”) value of similarity (e.g., “t”).

For example, a maximum connection width (e.g., Wmax) can be 100 mm, and a minimum connection width (e.g., Wmin) can be 1 mm. The width of a connection (e.g., edge) between two nodes can be determined by:

W=Wmax*(s−t)+Wmin (for s≧t)

and

W=0 (for s<t)

where s and t range in value from 0 to 1. The reader will appreciate from the linear relationship set forth above that as similarity between two projects changes, at or above the threshold value, the width of a connection (e.g., edge) between nodes representing the two projects will vary from Wmin to Wmax Wmin.

The reader will also understand that according to one or more embodiments, a user can increase or decrease the threshold value, which in turn can change the width (e.g., thickness) of all displayed connections (e.g., edges). Increasing the threshold can change the characteristic (e.g., decrease the width) of every connection, and may cause some connections to disappear for having a similarity below the increased threshold, along with their respective nodes if no other connections include the affected nodes, as will be explained further below.

Conversely, decreasing the threshold can oppositely change the characteristic (e.g., increase the width) of every connection, and may cause some connections to appear (along with their respective nodes) that were not previously visible as their similarity might now exceed the decreased threshold. In this manner, the connection characteristic (e.g., edge width) can be made to vary continuously between two states of the characteristic.

According to one or more embodiments of the present disclosure, the states of the connection (e.g., edge) characteristic indicating the strength of similarity between the projects represented by the connected nodes can be limited to a number of discrete states, rather than be continuously variable between two states (e.g., a maximum width and a minimum width). For example, three connection characteristic states (e.g., line thicknesses) are shown in FIG. 1, thin, medium, and thick. These characteristic states may represent three states along a continuum corresponding to a precise similarity measure, or may represent threes discrete states, each corresponding to some respective range of similarities.

By either the continuous similarity indication, or an implementation of discrete steps of similarity, the three connection characteristic states shown in FIG. 1 can correspond to relatively weak, medium, and strong similarities respectively. Embodiments of the present invention are not limited to any particular number of discrete characteristic states, and may have more, or fewer, than the three illustrated in FIG. 1. The three connection characteristic states depicted in FIG. 1 (e.g., thin, medium, and thick line widths), can represent a computed similarity between projects being within one of a number (e.g., three) of discrete similarity ranges. However, the discussion that follows assumes that the connection (e.g., edge) characteristic (e.g., width) indicates the strength of similarity between the projects represented by the connected nodes that vary continuously from a minimal connection width to a maximal connection width, unless otherwise indicated.

Nodes are positioned apart from one another by some distance on the project relationship diagram. That is, the nodes in each pair of connected nodes are positioned apart from one another by some distance, and nodes that are not connected are positioned apart from one another as well. As a result, clusters of nodes will be discernable from one another since clusters will be located separate from one another. The distance between nodes is related to a force 110 acting to separate the nodes from one another (e.g., according to a spring model used to place the nodes on the project relationship diagram). Node placement is discussed further with respect to FIG. 2 below.

FIG. 2 illustrates a project relationship diagram having a similarity threshold of 0.35, according to one or more embodiments of the present disclosure. The project relationship diagram 200 shown in FIG. 2 provides a high level view derived from a specified group (e.g., entire set) of projects. The project relationship diagram 200 easily indicates which projects are related in some specified manner, and the degree (e.g., strength, magnitude, type) of similarity of each relationship. The project relationship diagram 200 can be displayed on a graphical user interface (GUI) of a computing device, which may be a portion of a computing system, including one or more processors executing instructions to store project date, perform the project relationship analysis, and/or implement the display of the results of the project relationship analysis.

The project relationship diagram 200 can show a subset of all projects. The subset can include all projects. According to the embodiment illustrated in FIG. 2, a node representing a project that does not have a relationship with at least one other project that meets or exceeds a threshold measure, as determined by the project relationship analysis, is not shown in the project relationship diagram 200 (e.g., to simplify the diagram). However, embodiments of the present invention are not so limited, and the project relationship diagram 200 can be configured to display individual projects that lack a relationship to any other project, as indicated by a connection between a pair of nodes representing the respective projects.

As shown in FIG. 2, not displaying projects that do not have a connection to at least one other project, results in the project relationship diagram 200 showing only clusters of projects (e.g., two or more related projects). Thickness of the connection is used in the project relationship diagram 200 to indicate relative strength of similarity between connected projects, Thus, a user can quickly observe those projects having relationships, as well as judge the relative strength of those relationships (e.g., similarity).

The project relationship diagram 200 includes cluster 202-1 including two nodes 204 (representing projects), there being a relatively weak similarity between the projects as indicated by the thin connection 206-1 between nodes 204 of cluster 202-1. Cluster 202-1 is similar to cluster 102-1 shown in FIG. 1. Although not shown in FIG. 2, nodes 204 can be labeled with indicia of the project they represent (e.g., within the node symbol).

The project relationship diagram 200 also includes cluster 202-2 including two nodes 204 (representing projects) having a relatively strong similarity between the related projects, as indicated by the thick connection 206-2 between nodes 204 of cluster 202-2. Cluster 202-2 is similar to cluster 102-2 shown in FIG. 1. The project relationship diagram 200 additionally includes cluster 202-3 including two nodes 204 (representing projects) having a similarity between the related projects somewhere intermediate between being relatively weak and being relatively strong, as indicated by the medium thickness connection 206-3 between nodes 204 of cluster 202-3. Cluster 202-3 is similar to cluster 102-3 shown in FIG. 1.

According to one or more embodiments of the present invention, in addition to, or in lieu of, strength of similarity of a relationship between projects (represented by nodes on a project relationship diagram), a characteristic of the connection between projects can indicate other attributes concerning the relationship and/or one or more attributes of a project. For example, thickness of the connection could be an indication of strength of similarity, and/or color of the connection could indicate the most similar attribute (e.g., project cost, duration, etc.), and/or connection line style (e.g., solid, dotted, dashed, double line, etc.) could indicate yet another project relationship attribute (e.g., project technology). In this manner, any number of visual characteristics of the connection indication can be used to simultaneously convey strength of similarity between the projects, and/or other project relationship aspects.

Related projects, as represented by inter-connected nodes corresponding to the respective projects being in proximity to one another in the project relationship diagram 200 (e.g., clusters), can be determined by the project relationship analysis described in PCT Patent Application entitled “Method and System For Comparing And Locating Projects,” filed on the same date as the present application, and corresponding to HP Invention Disclosure 200903690-1. Project clustering in this manner facilitates rapid visualization of similarity between the clustered projects. Additionally, the strength of similarity is also readily discernable from the quantity or inter-connections between the projects of a cluster, and/or the magnitude of similarity visually communicated by the one or more characteristics of the connections (e.g., thickness, color, length, style, geometry, etc.). Thus, the project relationship diagram 200 assembled according to one or more embodiments of the present invention provides rapid and easy (simple, unobtrusive to the understanding) communication to a user, in a manner that is pleasing to comprehend, of large amounts of complex data, and further provides a means for drilling down to explore additional related detail for projects of interest.

As described with respect to a limited number of simple clusters in FIG. 1, projects are represented in FIG. 2 by the nodes of the project relationship diagram 200. The nodes can be represented by boxes, for example. Other node configurations and symbols are contemplated within the scope of the present embodiments. Each node may include information, symbol, coding, coloring, and/or other indicia identifying the particular project, project family, or other project characteristic associated with the project represented by the node. For example, a node can be labeled with a name or number identifying the project represented by the node.

Connections between nodes can have their characteristics chosen to reflect the degree of similarity between the projects represented by respective nodes. In FIG. 2, the degree of similarity between the projects represented by respective nodes is indicated by the thickness of the connection between nodes, as was described in more detail with respect to FIG. 1, thickness referring to the width of the line used to indicate a connection between nodes. A connection shown between two nodes indicates the existence of a relationship between the two projects represented by the nodes equal to and/or above a certain threshold level. That is, a connection indicates a similarity between the two projects that meets or exceeds some determination by the project relationship analysis computation.

Conversely, no connection between a particular pair of nodes indicates the similarity between the projects represented by the nodes does not meet or exceed the selected threshold. For example, no connection can indicate no similarity, or can indicate a similarity that is not sufficient to exceed the threshold selected to display a connection between the nodes representing the projects.

According to one or more embodiments of the present disclosure, a user can zoom in and out on the displayed project relationship diagram 200, or some selected portion thereof. According to one or more embodiments of the present disclosure, selecting a particular project can keep the selected project static on the GUI during zooming, and/or during other re-positioning of the other projects (e.g., as may occur by adjusting the similarity threshold).

Nodes representing projects are located on the project relationship diagram 200 according to a number of forces based on a force directed methodology simulating a virtual physical model, such as a spring model. According to one or more embodiments of the present disclosure, node positioning is determined according to a physical system by assuming a node is modeled as a ring of metal (or other stable physical vertex), and a connection between pairs of nodes is modeled as a spring attached to the nodes and exerting a force therebetween.

According to one or more embodiments of the present disclosure, individual nodes are subject to three forces in determining their respective positioning on the project relationship diagram 200: a gravitational force between each node and an origin position, a repulsive force between each pair of nodes (e.g., each node with respect to each of all the other nodes), and an attractive force proportional to the distance and strength of similarity between each pair of nodes.

Given some initial positioning of the nodes (e.g., arbitrary), the attractive forces between related nodes, and between each node and an origin position, as well as the opposing repulsive forces, force the nodes to positions on the project relationship diagram 200 that result in a locally minimal energy state (e.g., an equilibrium configuration). Such an equilibrium configuration can provide important aesthetic attributes, such as distributing vertices (e.g., nodes representing projects) evenly, making connection lengths uniform, minimizing connection crossings, and reflecting symmetric properties.

The origin position can be defined as the center of a visual frame in which the project relationship diagram 200 can be arranged. For example, the origin position can be set as the center of a GUI, such as a computer display. However, embodiments of the present disclosure are not so limited, and the origin position can be set at any convenient location, on or off of the display, That is, the origin position may initially be located at the center of the GUI within which the project relationship diagram 200 is displayed. However, as a user zooms in to a selected portion of the entire project relationship diagram 200, the origin position may be located at some other location on, or off, the GUI.

The gravitational force between each node and the origin position is used to keep the locations of nodes and/or clusters of nodes compact around the origin position. To the extent that the origin position is set as the center of the GUI upon which the project relationship diagram 200 is displayed, the gravitational force keeps the clusters of nodes compact within the display. The gravitational force can be constant and/or proportional to the distance between a particular node and the origin position. According to one or more embodiments, the strength of the gravitational force can be adjustable.

Pairs of nodes are subject to several forces, including an attractive force directionally aligned with a connection between a pair of nodes. The strength of the attractive force is proportional to the physical length of the connection between the nodes and the strength of the similarity (e.g., relationship) between the projects represented by the nodes. In this way, projects that are relatively more similar can have nodes located relatively closer together, and projects that are relatively less similar can have nodes located relatively farther apart. Thus, according to one or more embodiments, projects that are relatively more similar can have nodes located relatively closer together and a thicker connection therebetween, and projects that are relatively less similar can have nodes located relatively farther apart and a thinner connection therebetween.

According to one or more embodiments of the present disclosure, the attractive force is only applied between nodes having a similarity that is equal to or greater than a particular threshold. That is, the attractive force proportional to distance between nodes on the project relationship diagram 200, and/or the attractive force proportional to the strength of the similarity between the two projects represented by the nodes being connected, are only applied between nodes having a similarity that is equal to or greater than a particular threshold. Thus, one or both of the attractive forces are not applied between nodes that do not have a similarity equal to or greater than a particular threshold (e.g., as may be determined by a project relationship analysis).

According to one or more embodiments of the present disclosure, a repulsive force that acts to move the nodes apart is inversely proportional to the square of the distance between the nodes. The repulsive force acts between each node and all other nodes (e.g., each possible pair of nodes), regardless of whether the similarity between the projects represented by the particular pair of nodes is equal to or greater than a particular threshold.

According to one or more embodiments of the present disclosure, one method for locating nodes representing projects, and connections therebetween, on the project relationship diagram 200 involves initially placing the nodes and calculating forces between nodes based on the relative locations of the nodes with respect to the origin position and all other nodes. The different forces are applied by subsequently displacing individual nodes in a direction of the resultant force acting upon the individual node. A coordinate system can be used in determining node location, computing relative distances, and relative forces acting upon the individual nodes.

After displacing one or more nodes incrementally, new coordinates of the nodes are used to calculate new resultant forces acting on each node at the new (e.g., displaced) location, and the process is repeated until equilibrium is achieved (e.g., an incremental change to any node position increases the energy state of the system of nodes and connections).

According to one or more embodiments of the present disclosure, equilibrium can be checked by several methods, including minimizing total forces collectively applied to all of the nodes. That is, equilibrium can be defined as the node locations where total force to the system of nodes cannot be reduced any further by additional displacement of any one or more nodes. Once equilibrium is achieved, the project relationship diagram 200 can be displayed using the determined node positions and connections therebetween.

According to one or more embodiments of the present disclosure, the forces experienced by each node can be evaluated automatically (e.g., by a computing device), and checked for equilibrium by moving one or more nodes to determine if total forces collectively applied to all of the nodes are increased or reduced. Movements of nodes can continue in an iterative process until no further node movement result in the reduction of total forces collectively applied to all of the nodes. According to one or more embodiments of the present disclosure, a user can interrupt the iterative process of determining equilibrium, such as by providing an appropriate input to a computer-implemented system for displaying project relationships.

The reader will appreciate that intermediate results of the iterative process of incrementally moving node, testing changes to a total forces collectively applied to all of the nodes, moving nodes, etc. can be displayed, or otherwise output from a computer-implemented system. That is, according to one or more embodiments, the node positions are displayed as they evolve from an initial positioning towards an equilibrium position. As such, a user can intervene to stop the iterative calculations as a meaningful result graphically emerges via the displayed results. According to one or more embodiments, a threshold (e.g., of similarity) can be set (e.g., by user input) that stops the iterative process of determining equilibrium as the threshold is reached.

According to one or more embodiments of the present disclosure, a user can interactively adjust the similarity threshold used as a basis for determining the existence of a connection between a pair of nodes (e.g., similarity such as can be determined by a project relationship analysis is equal to or greater than the selected similarity threshold). Projects having a similarity determined to be above a selected threshold can be shown on the project relationship diagram 200 having a connection between the nodes representing the related projects, as has been previously described. Nodes corresponding to the related projects can have attractive forces applied to the corresponding nodes representing the projects in a direction of the connection between the nodes.

The similarity threshold, as used herein, intends the similarity required to indicate (e.g., show on the project relationship diagram 200 and apply attractive forces) a connection between nodes representing the related projects. According to one or more embodiments of the present disclosure implemented using a number of discrete connection widths, rather than continuously varying connection widths, the range of similarity indicated by a particular connection width can be individually set. For example, additional similarity thresholds may be manually set for each discrete connection width, or derived from the similarity threshold set for displaying connections. For example, a first level (e.g., “thin”) similarity threshold for indicating a connection by a first type of the connection characteristic (e.g., a thin line) may be set equal to the similarity threshold for showing any connection. Thus, projects that have a similarity equal to or greater than the first level similarity threshold, but less than a second level similarity threshold, can be shown by a thin connection between the nodes representing the related projects.

A second level (e.g., “medium”) similarity threshold for indicating a connection by a second type of the connection characteristic (e.g., a medium thickness line) may be set independently, or determined from the similarity threshold and/or the first level similarity threshold. Thus, projects that have a similarity equal to or greater than the second level similarity threshold, but less than a third level similarity threshold, can be shown by a medium connection between the nodes representing the related projects.

A third level (e.g., “thick”) similarity threshold for indicating a connection by a third type of the connection characteristic (e.g., a thick line) may be set independently, or determined from other similarity threshold(s). Thus, projects that have a similarity equal to or greater than the third level similarity threshold can be shown by a thick connection between the nodes representing the related projects.

When similarity threshold(s) are changed, certain connections can come into, or go out of, existence, triggering different total forces. The change in connections can cause nodes to appear, or disappear, from the project relationship diagram 200. For example, nodes not having at least one connection to another node may be not shown on the project relationship diagram 200. Therefore, when certain connections become no longer visible due to a change in the similarity threshold, some nodes may be left without any other connections, and thus are removed from being displayed. Conversely, nodes previously without any connection, and thus not appearing on the project relationship diagram 200, can appear as the similarity threshold is decreased to a level permitting a connection to the node to qualify for being visible, and thus the node is shown along with the new visible connection.

Changing the similarity threshold and the resulting change in connections (appearance and/or disappearance) can change the forces acting on a particular node, since attractive forces may only applied when a visible connection is established. According to one or more embodiments of the present disclosure, forces on each node are re-calculated when the similarity threshold is adjusted (e.g., changed). According to one or more embodiments of the present disclosure, forces on each node are not re-calculated when the similarity threshold is adjusted (e.g., changed), so as to maintain relative positioning of the nodes and/or clusters for comparisons of the project relationship diagram 200 between different similarity threshold values.

In a similar manner, the criteria for computing similarity in the project relationship analysis can impact, and thus change, computed similarities between projects. Similarities between certain projects can change relative to a constant similarity threshold when the way in which similarity is measure changes. If the definition of similarity, or the inputs used to measure similarity, change, the resulting similarity result can change. The reader will understand that changing the computed similarity between projects can cause similar changes to the display of projects as was described above with respect to changing the similarity threshold relative to a constant project relationship analysis methodology.

That is, the relationships displayed between projects can change similarly when the computed similarity between projects is changed relative to a constant similarity threshold, or when the similarity threshold is changed relative to a constant computation of similarity between projects. The reader will appreciate that changing the similarity threshold does not change the computed similarity between pairs of projects, only the indication of similarity on the display (e.g., connection width). It may be beneficial to adjust the settings of the project relationship diagram 200, by one or more means in order to make existing and/or relevant clusters evident to the user (e.g., analyst).

FIG. 2 shows a number of relatively thin connections 206-4. Nodes 204X are present in the project relationship diagram 200 shown in FIG. 2, as being one of the nodes representing a project having a relatively weak similarity to one or more other projects, as indicated by a relatively thin connection thereto. Nodes 204W are also present in the project relationship diagram 200 shown in FIG. 2, as being nodes representing a project having a relatively weak similarity to one or more other projects, as indicated by a relatively thin connection thereto. However, unlike nodes 204X, nodes 204W have at least one additional connection that is not relatively thin (e.g., indicating a relatively weak similarity).

The relatively thin connection 206-10 indicates a relatively weak similarity between two projects, the nodes of which each having no other connections thereto. The relatively thick connection 206-7 indicates a relatively strong similarity between a pair of projects, and the relatively medium width connection 206-5 indicates a relatively medium (e.g., between weak and strong) similarity between a pair of projects.

FIG. 2 further illustrates the repulsive forces 210 between one node (e.g., 204Z) and its closest neighboring nodes 204Y. Similar repulsive forces 210 exist between the one node (e.g., 204Z) and all other nodes; however, as the distances therebetween are increasingly greater than for the neighboring nodes 204Y, the repulsive force is correspondingly less than attributable between the one node (e.g., 204Z) and its closest neighboring nodes 204Y.

FIG. 2 shows the gravitational force 212 acting on one representative node and the origin position 201. Each node would experience a similar attractive force towards the origin position 201 (e.g., the center of the project relationship diagram, center of an electronic display, user-selected reference point, etc.).

FIG. 3 is a project relationship diagram having a similarity threshold of 0.5, according to one or more embodiments of the present disclosure. The origin position of the project relationship diagram is shown at 301. Compare the project relationship diagram 300 shown in FIG. 3, which reflects an increased similarity threshold, to the project relationship diagram 200 shown in FIG. 2. The reader will appreciate that although changing the similarity threshold does not change the computed similarity between pairs of projects, some project similarities shown in FIG. 2 are no longer present in FIG. 3, such as those represented by nodes 204X in FIG. 2.

No nodes corresponding to nodes 204X in FIG. 2 are shown in FIG. 3 because connections 206-4, indicating a particular level of similarity (e.g., relatively weak), no longer qualify to be displayed at the higher similarity threshold of FIG. 3. Thus, certain relatively weak connections are removed from FIG. 3 as compared to FIG. 2, and any resulting nodes that no longer have any connections (e.g., similarity to any other project) at the increased threshold for establishing similarity, are also removed from FIG. 3.

Relatively thin connection 306-6 indicates a relatively weak similarity between two projects in FIG. 3, which is less strong than the relatively medium similarity between the same two projects in FIG. 2 at connection 206-6. Relatively medium connection 306-7 indicates a medium (e.g., intermediate) similarity between two projects in FIG. 3, which is less strong than the relatively strong similarity between the same two projects in FIG. 2, as indicated by the relatively thick connection 206-7.

However, if the present disclosure is implemented using a number of discrete connection widths, each indicating a range of similarity, the similarity indicate between a pair of projects may not show a change as a result of a changing similarity threshold. That is, where a number of discrete connection widths are possible, the change in similarity threshold may not be sufficient to cause the constant computed similarity between certain projects to move into ranges that can be adjusted as a result of the different similarity threshold. Accordingly, a constant similarity can be shown with a different connection width when the similarity threshold changes, even where the present disclosure is implemented using a number of discrete connection widths rather than continuously-variable connection widths.

For implementations of the present disclosure using continuously variable connection widths, changes to computed similarity, such as those that can result from a change to the similarity threshold, will be reflected in a correspondingly different connection width (albeit the change in connection width may be too small to discern with the naked eye for small changes in the similarity threshold).

With respect to implementations utilizing a number of discrete connection widths, each corresponding to a discrete similarity range, FIG. 3 can be interpreted as connection 306-9 remaining shown as a medium thickness connection despite the change to threshold similarity to indicate a similarity of the connected projects remaining within the range of similarities represented by the medium thickness connection (e.g., between a relatively weak and relatively strong similarity). Similarly, connection 306-8 remained shown as a thick connection to indicate a similarity of the connected projects remaining relatively strong, despite the increase in similarity threshold from 0.35 in FIG. 2 to 0.5 in FIG. 3.

Also note that the loss of a connection does not necessarily result in the nodes previously connected being removed from the project relationship diagram. For example, connection 206-5 shown in FIG. 2, between nodes 204W, no longer appears in FIG. 3. However, each of the nodes 204W connected by connection 206-5 remain present in the project relationship diagram 380 shown in FIG. 3 at the higher similarity threshold setting because nodes 304W remain related to at least one other project by equal to or greater than the increased threshold similarity for the project relationship diagram 300 of FIG. 3.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for displaying project relationships, comprising:
providing a plurality of nodes (104A-F, 204, 204W-Z, 304W) on an electronic display, each node (104A-F, 204, 204W-Z, 304W) representing a project;
arranging the plurality of nodes (104A-F, 204, 204W-Z, 304W) according to forces acting on each node (104A-F, 204, 204-Z, 304W); and
showing a connection (106-1, 106-2, 106-3, 206-1, . . . , 206-7, 206-10, 306-5, . . . 306-10) between certain pairs of nodes (104A-F, 204, 204W-Z, 304W) to indicate existence of at least a threshold measure of similarity between projects represented by the connected nodes (104A-F, 204, 204W-Z, 304W), at least one characteristic of the connection (106-1, 106-2, 106-3, 206-1, . . ., 206-7, 206-10, 306-5, 306-10) visually indicating a measure of the similarity,
wherein the forces acting on each node (104A-F, 204, 204W-Z, 304W) includes a constant attractive force (212) between each node (104A-F, 204, 204W-Z, 3041) and an origin position (201, 301) on the electronic display, a repulsive force (110, 210) between each pair of nodes (104A-F, 204, 204W-Z, 304W) proportional to the distance therebetween, and an attractive force between connected nodes (104A-F, 204, 204W-Z, 304W) proportional to the measure of similarity.

2. The method of claim 1, wherein the repulsive force (110, 210) between each pair of nodes (104A-F, 204, 204W-Z, 304W) proportional to the distance therebetween is greater than the constant attractive force (212) between each node (104A-F, 204, 204W-Z, 304W) and an origin position (201, 301) on the electronic display.

3. The method of claim 1, wherein arranging the plurality of nodes (104A-F, 204, 204W-Z, 304W) includes positioning the plurality of nodes (104A-F, 204, 204W-Z, 304W) about the electronic display so as to minimize intersection of connections (106-1, 106-2, 106-3, 206-1, . . . , 206-7, 206-10, 306-5, . . . , 306-10) between the certain pairs of nodes (104A-F, 204, 204W-Z, 304W).

4. The method of claim 1, wherein arranging the plurality of nodes (104A-F, 204, 204W-Z, 304W) on the electronic display includes positioning the plurality of nodes (104A-F, 204, 204W-Z, 304W) so that connections (106-1, 106-2, 106-3, 206-1, . . . , 206-7, 206-10, 306-5, 306-10) therebetween all have a uniform length.

5. The method of claim 1, wherein arranging the plurality of nodes (104A-F, 204, 204W-Z, 304W) on the electronic display includes positioning the plurality of nodes (104A-F, 204, 204W-Z, 304W) to minimize, in the aggregate, the number of forces acting on the plurality of nodes (104A-F, 204, 204W-Z, 304W).

6. The method of claim 1, wherein each node (104A-F, 204, 204W-Z, 304W) is labeled with an identifier corresponding to the project represented by the respective node (104A-F, 204, 204W-Z, 304W).

7. The method of claim 1, wherein the measure of the similarity quantifies a user-specified relationship between projects based on selected project attributes.

8. The method of claim 1, further including omitting a connection (106-1, 106-2, 106-3, 206-1, . . . 206-7, 206-10, 306-5, . . . 306-10) between certain pairs of nodes (104A-F, 204, 204W-Z, 304W) to indicate absence of at least a threshold measure of similarity between projects represented by the certain pairs of nodes (104A-F, 204, 204W-Z, 304W),

9. The method of claim 1 wherein the threshold is user-selectable.

10. A computer-readable medium comprising computer-readable instructions for displaying project relationships, the computer-readable instructions comprising instructions for:
providing a plurality of nodes (104A-F, 204, 204W-Z, 304W) on an electronic display, each node (104A-F, 204, 204W-Z, 304W) representing a project;
arranging the plurality of nodes (104A-F, 204, 204W-Z, 304W) about the electronic display according to a number of forces acting on each node (104A-F, 204, 204W-Z, 304W), the number of forces including a constant attractive force (212) between each of the plurality of nodes (104A-F, 204, 204W-Z, 304W) and an origin position (201, 301) of the electronic display, a repulsive force (110, 210) between each pair of nodes (104A-F, 204, 204W-Z, 304W) proportional to the distance therebetween, and an attractive force between connected nodes (104A-F, 204, 204W-Z, 304W) proportional to a measure of similarity; and
showing a connection (106-1, 106-2, 106-3, 206-1, . . . 206-7, 206-10, 306-5, . . . , 306-10) between selected pairs of nodes (104A-F, 204, 204W-Z, 304W) to indicate existence of one or more requested relationships between projects represented by the nodes (104A-F, 204, 204W-Z, 304W),
wherein at least one characteristic of the connection (106-1, 106-2, 106-3, 206-1, . . . 206-7, 206-10, 306-5, . . . 306-10) visually indicates a measure of the requested relationship between projects represented by the nodes (104A-F, 204, 204W-Z, 304W).

11. The method of claim 10, wherein each node (104A-F, 204, 204W-Z, 304W) includes a link to project data executable by selection of a corresponding node (104A-F, 204, 204W-Z, 304W), the project data including information about the project represented by the selected node (104A-F, 204, 204W-Z, 304W).

12. The method of claim 11, wherein the project data includes information about one or more projects having a connection (106-1, 106-2, 106-3, 206-1, . . . , 206-7, 206-10, 306-5, . . . , 306-10) to the project represented by the selected node (104A-F, 204, 204W-Z, 304W).

13. The method of claim 12, wherein the project data includes information about information relating to the measure of similarity of the one or more projects having a connection to the project represented by the selected node (104A-F, 204, 204W-Z, 304W).

14. A system for displaying project relationships, the system comprising:
a display; and
one or more computing devices programmed with computer-readable instructions executing on one or more processors to:
provide a plurality of nodes (104A-F, 204, 204W-Z, 304W) on an electronic display, each node (104A-F, 204, 204W-Z, 304W) representing a project;
arrange the plurality of nodes (104A-F, 204, 204W-Z, 304W) about the electronic display according to a number of forces acting on each node (104A-F, 204, 204W-Z, 304W), the number of forces include a constant attractive force (212) between each of the plurality of nodes (104A-F, 204, 204W-Z, 304W) and an position (201, 301) of the electronic display, a repulsive force (110, 210) between each pair of nodes (104A-F, 204, 204W-Z, 304W) proportional to the distance therebetween, and an attractive force between connected nodes (104A-F, 204, 204W-Z, 304W) proportional to a measure of similarity: and
show a connection (106-1, 106-2, 106-3, 206-1, . . . 206-7, 206-10, 306-5, . . . 306-10) between selected pairs of nodes (104A-F, 204, 204W-Z, 304W) to indicate existence of one or more requested relationships between projects represented by the nodes (104A-F, 204, 204W-Z, 304W),
wherein at least one characteristic of the connection (106-1, 106-2, 106-3, 206-1, . . . 206-7, 206-10, 306-5, 306-10) visually indicates a measure of the requested relationship between projects represented by the nodes (104A-F, 204, 204W-Z, 304W).

15. The method of claim 14, wherein the at least one characteristic of the connection (106-1, 106-2, 106-3, 206-1, . . . , 206-7, 206-10, 306-5, . . . , 306-10) between the certain pairs of nodes (104A-F, 204, 204W-Z, 304W) is visually indicated by the thickness of the connection (106-1, 106-2, 106-3, 206-1, . . . 206-7, 206-10, 306-5, . . . 306-10).
